(19) United States
(12) Patent Application Publication
(10) Pub. No.: US 2013/0285985 A1
(43) Pub. Date: Oct. 31, 2013

(54) METHOD AND DEVICE FOR ASCERTAINING A GESTURE PERFORMED IN THE LIGHT CONE OF A PROJECTED IMAGE

(71) Applicants: Stefan PINTER, Reutlingen (DE); Reiner SCHNITZER, Reutlingen (DE); Frank FISCHER, Gomaringen (DE); Gael PILARD, Wankheim (DE); Ming LIU, Reutlingen (DE); David SLOGSNAT, Tuebingen (DE); Daniel KREYE, Reutlingen (DE); Tobias HIPP, Hechingen (DE)

(72) Inventors: Stefan PINTER, Reutlingen (DE); Reiner SCHNITZER, Reutlingen (DE); Frank FISCHER, Gomaringen (DE); Gael PILARD, Wankheim (DE); Ming LIU, Reutlingen (DE); David SLOGSNAT, Tuebingen (DE); Daniel KREYE, Reutlingen (DE); Tobias HIPP, Hechingen (DE)

(73) Assignee: Robert Bosch GmbH, Stuttgart (DE)

(21) Appl. No.: 13/869,759

(22) Filed: Apr. 24, 2013

(30) Foreign Application Priority Data
Apr. 25, 2012 (DE) 10 2012 206 851.1

(51) Int. Cl. G06F 3/042

(52) U.S. Cl. CPC G06F 3/0421
USPC 345/175

(57) ABSTRACT

A method for ascertaining a gesture performed in the light cone of a projected image which has a plurality of pixels includes: detecting all pixels of the projected image and one or multiple parameter values of the individual pixels; comparing the one or the multiple detected parameter values of the individual pixels with a parameter comparison value; assigning a subset of the pixels to a pixel set as a function of the results of the comparison; and ascertaining a gesture performed in the light cone of the projected image based on the assigned pixel set.

### BACKGROUND OF THE INVENTION

1. Field of the Invention

The present invention relates to a method and a device for ascertaining a gesture performed in the light cone of a projected image.

2. Description of the Related Art

Published European patent application document EP 2 056 185 A2 describes a gesture detection device, which uses non-visible light for detecting objects in a projection cone. The gesture detection and image analysis is based on data of an infrared sensor, which detects light beams reflected by a user's hand or finger.

U.S. Patent Application Publication US 2011/0181553 A1 describes a method for an interactive projection including gesture detection.

U.S. Patent Application Publication US 2009/0189858 A1 discloses a gesture detection system, in which for the purpose of detecting objects a periodic light pattern is projected onto the object to be detected.

U.S. Patent Application Publication US 2010/0053591 A1 describes a method and a device for using pico projectors in mobile applications. In the method described in the latter document, the use of a laser projector is combined with an analysis of the reflected light for detecting objects.

U.S. Patent Application Publication US 2011/0181553 A1 describes a device for detecting a cursor position on an illuminated projection screen of a video projector projecting an image. This cursor position is determined as the most distant position of an obstacle from the section of the edge of the projected image, from which the obstacle extends into the projected image.

### BRIEF SUMMARY OF THE INVENTION

The present invention provides a method for ascertaining a gesture performed in the light cone of a projected image, which has a plurality of pixels, including the method steps: detecting all pixels of the projected image and one or multiple parameter values of the individual pixels; comparing the one or the multiple detected parameter values of the individual pixels with a parameter comparison value and assigning a subset of the pixels to a pixel set as a function of the results of the comparison; and ascertaining a gesture performed in the light cone of the projected image based on the assigned pixel set.

The present invention further provides a device for ascertaining a gesture performed in the light cone of a projected image including: a projector device for projecting the image onto a projection screen, a sensor device for detecting pixels of the projected image and for detecting one or multiple parameter values of the individual pixels, and a data processing device for comparing the one or the multiple detected parameter values of the individual pixels with a parameter comparison value and for assigning a subset of the pixels to a pixel set as a function of the results of the comparison and for ascertaining the gesture performed in the light cone of the projected image based on the assigned pixel set.

An object of the present invention is to limit the data processing and storing to image areas that are important for gesture detection and that are selected on the basis of changes in parameter values.

One idea of the present invention is to ascertain for this purpose those coordinates on the projection screen of the projector at which the distance between the projector and the projection screen changes locally in a significant way. Within one frame, only these coordinates are stored in a memory unit of the projector and may be processed further by a processor of the device. Alternatively, it is possible to store only those coordinates at which the reflection factor of the projection screen changes significantly.

One advantage of the present invention is that an object may be detected without extensive storage requirement in a laser scanner. Consequently, only the contour coordinates of an object located in the projection cone are stored. This keeps the storage requirement in detecting gestures within the projector very low.

For the purpose of gesture detection such as the detection of a pointer or a finger in the image of a pico projector, the essence of the present invention is furthermore to ascertain the coordinates on the projection screen at which the distance between the projector and the projection screen changes locally in a significant way. According to the present invention, within one frame, only these coordinates are stored in the memory unit of the projector and may be retrieved by an application processor of the pico projector.

Alternatively, it is possible to store the coordinates at which the reflectivity of the projection screen changes significantly.

For evaluating the significance of the change in distance or reflectivity, the distance between the light source and the reflecting surface at the respective pixel is ascertained during the row movement or another kind of raster movement of a scanner mirror of the device, for example by a so-called time-of-flight measurement or using the phase shift method. The ascertained value is compared with the value of the adjacent pixel in the row.

If the ascertained value changes more drastically from pixel to pixel than a defined threshold value, then the change is significant and the corresponding row and column coordinate is registered in the memory unit or a coordinate pair ascertained from it is registered at a reduced spatial resolution in order to save memory space and processing power requirements of the device by reducing the quantity of data.

According to one specific embodiment of the present invention, distances between the pixels projected onto a projection screen and a projector device projecting the image are used as the parameter values of the pixels.

According to another specific embodiment of the present invention, the column-wise and/or row-wise scanning of the pixels of the projected image is performed synchronously with a column-wise and/or row-wise projection of the image.

According to another specific embodiment of the present invention, the parameter comparison value is ascertained on the basis of the parameter values of the previously detected pixels.

According to another specific embodiment of the present invention, reflectivity values of the pixels projected onto a projection screen are used as the parameter values of the pixels.

According to another specific embodiment of the present invention, the pixels are assigned to the pixel set as a function of a geometrical shape of the pixel set.

According to another specific embodiment of the present invention, the pixels of the projected image are detected by a column-wise and/or row-wise scanning of all pixels of the projected image.

According to another specific embodiment of the present invention, the sensor device has a distance sensor for detecting distances between the pixels projected onto a projection screen and a projector device projecting the image.

The enclosed drawings are intended to convey further understanding of the specific embodiments of the present invention. They illustrate specific embodiments and in connection with the description serve to explain principles and concepts of the present invention. The represented elements of the drawings are not necessarily drawn to scale with respect to one another.

### BRIEF DESCRIPTION OF THE DRAWINGS

FIG. 1 shows a schematic representation of a device for ascertaining a gesture performed in the light cone of a projected image according to a specific embodiment of the present invention.

FIGS. 2-3 respectively show a schematic representation of an assignment of pixels according to another specific embodiment of the present invention.

FIG. 4 shows a schematic representation of a device for ascertaining a gesture performed in the light cone of a projected image according to another specific embodiment of the present invention.

FIG. 5 shows a schematic representation of a graph of a location dependence of a parameter value according to one specific development of the present invention.

FIGS. 6-7 respectively show a schematic representation of an assignment of pixels according to another specific embodiment of the present invention.

FIG. 8 shows a schematic representation of a device for ascertaining a gesture performed in the light cone of a projected image according to a specific embodiment of the present invention.

FIG. 9 shows a schematic representation of a flow chart of a method for ascertaining a gesture performed in the light cone of a projected image according to a specific embodiment of the present invention.

### DETAILED DESCRIPTION OF THE INVENTION

In the figures of the drawing, identical reference symbols indicate identical or functionally equivalent elements, parts, components or method steps unless indicated otherwise.

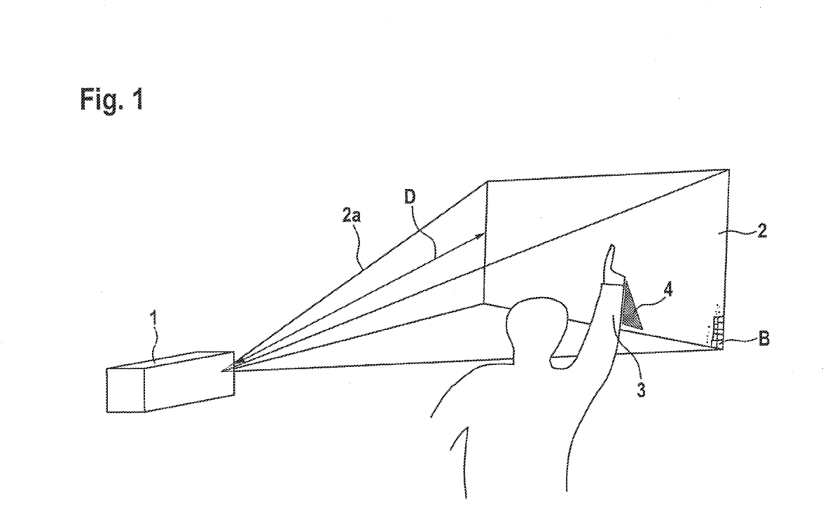

FIG. 1 shows a schematic representation of a device for ascertaining a gesture performed in the light cone of a projected image according to a specific embodiment of the present invention.

A device 1 for ascertaining a gesture performed in the light cone of a projected image projects an image 2 onto a projection screen 11. Device 1 is equipped with a distance sensor, which is designed to detect distances D between the pixels B projected onto the projection screen 11 and a projector device 103 of device 1 that projects image 2.

Pixels B are developed for example as pixels, image points, image cells or image elements. Pixels B are furthermore developed as the individual color values of a digital raster graphic. Pixels B are for example pixels or image points arranged in the form of a raster.

FIG. 1 shows how a user reaches with his arm 3 into a projection cone 2a used for projecting image 2 and thereby produces a shadow 4 on projection screen 11. Using a finger 8 of arm 3, the user marks a certain position on projection screen 11.

Apart from the gesture shown in FIG. 1, in which a point on projected image 2 is marked using finger 8, other gestures are also conceivable as gestures to be ascertained by device 1. Furthermore, it is also conceivable to use, instead of finger 8, another object or another pointing instrument when performing the gesture such as a pointer or a laser pointer used in presentations.

FIG. 2 shows a schematic representation of an assignment of pixels according to another specific embodiment of the present invention.

In the method for ascertaining a gesture performed in light cone 2a of a projected image 2, an image detection algorithm is used for example to detect edge points 6 of the user's arm 3. Arm 3 of the user is partially illuminated by light cone 2a, thereby defining an edge line 5 dividing arm 3 into an illuminated area and an non-illuminated area.

Edge points 6 of arm 3 are detected using a significance evaluation of the image detection algorithm. For example, the coordinates of the circumferential edge points 6 of arm 3 are stored in a memory unit and are provided to an application processor or another data processing device of device 1.

The image detection algorithm uses for example detected parameter values P of the individual pixels B and compares these with a parameter comparison value PS. Subsequently, pixels B are assigned to a pixel set BM as a function of the results of the comparison.

For evaluating the significance of the change in distance or the change in reflectivity, the distance between the light source of device 1 and the reflecting surface of projection screen 11 at the respective pixel B is ascertained during the row movement of a scanner mirror of device 1 and thus during the projection of pixel B.

This occurs for example by flight time methods, also called time-of-flight measurements, or by phase shift methods. The ascertained value is compared with the value of adjacent pixel B in the row or in the column.

If the ascertained parameter value changes relatively from pixel B to pixel B more drastically than a defined parameter comparison value or another threshold value, then the change of the parameter value of the respective pixel B is significant and the corresponding row and column coordinate of pixel B is registered in the memory unit. In determining the jump of the parameter value in the row or in the column, it is also possible to buffer data and evaluate them using filter algorithms such as for example a sliding average formation over 2 to 50 pixels of a row or of a column.

For example, the significance evaluation may be performed, not relatively from the comparison of the values of adjacent measuring points, but rather the significance evaluation may be performed absolutely with reference to a parameter comparison value PS used as reference measure.

If a distance value or a reflectivity value is ascertained that is greater than the reference measure, then these coordinates are stored as a pair in a memory unit of the device and are assigned to a pixel set BM. The average distance D of the projector from projection screen 11 is used for example as reference measure.

Distance D may be ascertained on undisturbed projection screen 11, i.e. without coverage by an object, simply by averaging many distance values. It is furthermore possible to determine the average distance D by sections and to compare it in the object detection with the average distance D applicable to this section. Due to the short projection distance that is typical in the use of a device comprising a pico projector as projector device 103, it is advantageous in this regard that there are locally clear distance variations between the light source and projection screen 11.

Moreover, for the purpose of the significance evaluation, not only a lower threshold value or a minimum measure of the change may be used as parameter comparison value, but also an upper threshold value for the change of the distance from point to point or an upper limiting value for the difference in distance between the reference value and the measured value may be defined.

The criteria as to whether a lower threshold value is exceeded or undershot and whether an upper threshold value was exceeded or undershot may be defined independently of one another or these criteria may be logically linked to one another.

The other reference symbols represented in FIG. 2 were already described in the description of FIG. 1 and are thus not explained further.

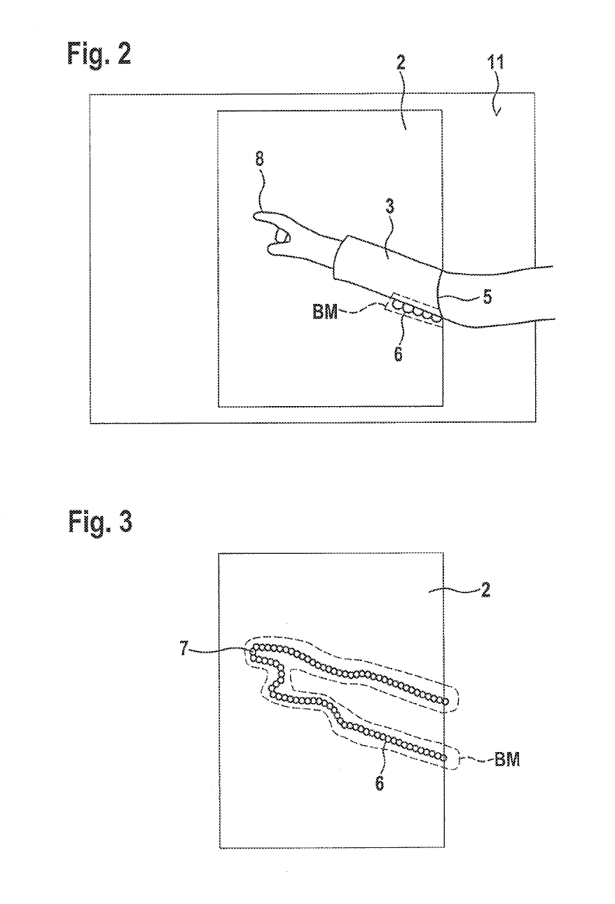

FIG. 3 shows a schematic representation of an assignment of pixels according to another specific embodiment of the present invention.

FIG. 3 shows edge points 6 of an arm 3. Edge points 6 form a pixel set BM, which depict a geometrical shape 20, 21 of arm 3. Pixel set BM further includes a relevant pixel 7, which represents a relevant position such as the tip of a pointer for example, which corresponds to a finger 8.

The other reference symbols represented in FIG. 3 were already described in the description of FIG. 1 and are thus not explained further.

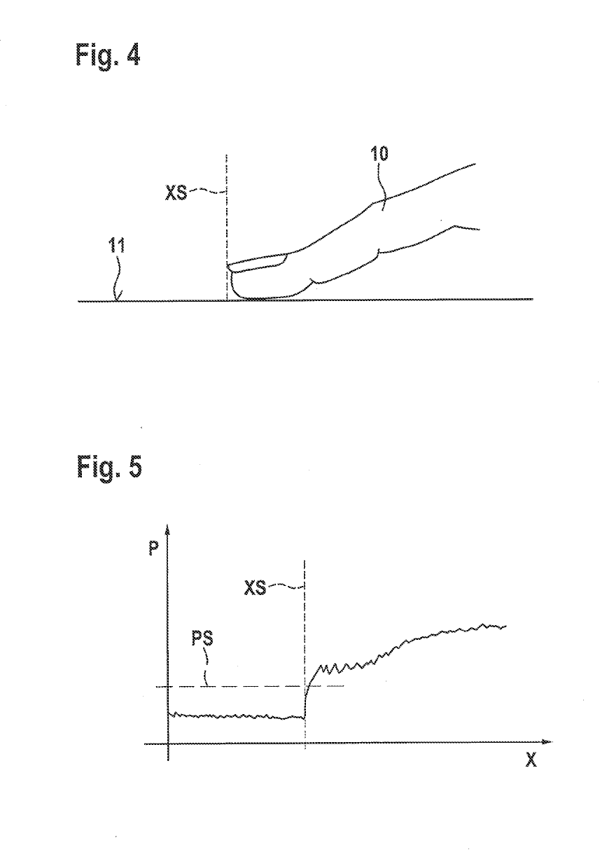

FIG. 4 shows a schematic representation of a device for ascertaining a gesture performed in the light cone of a projected image according to another specific embodiment of the present invention.

Projection screen 11 is covered by an object 10. Object 10 is for example a finger performing a gesture. Projection screen 11 may be developed as a projection screen, a silver screen or another reflective surface, which scatters light diffusely and on which a reflection of projected image 2 is produced. The coverage of projection screen 11 by object 10 extends up to a position XS.

FIG. 5 shows a schematic representation of a graph of a location dependence of a parameter value according to one specific development of the present invention.

Distance D between pixels B projected onto a projection screen 11 and projector device 103 projecting image 2 is plotted as parameter value P on the y-axis of the graph. A specified parameter comparison value PS is furthermore recorded on the y-axis.

The x-axis of the graph corresponds to the spatial coordinate x, and position XS already described in FIG. 4 is furthermore drawn in on the x-axis. Parameter value P rises suddenly at position XS.

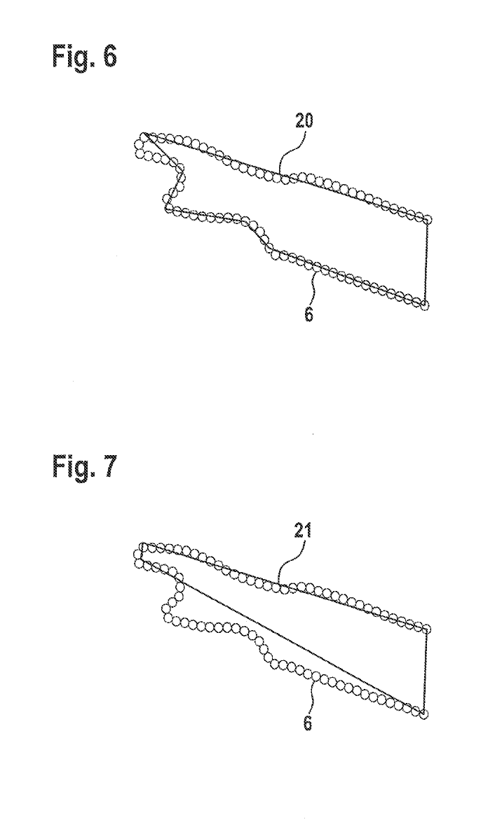

FIG. 6 shows a schematic representation of an assignment of pixels according to another specific embodiment of the present invention.

A geometrical shape 20 is defined by a pixel set BM having edge points 6. The geometrical shape 20 represented in FIG. 6 is developed as a polygon and corresponds to a user's arm 3.

FIG. 7 shows a schematic representation of an assignment of pixels according to another specific embodiment of the present invention.

A geometrical shape 21 is defined as a subset of pixels B by a pixel set BM having edge points 6. The geometrical shape 20 represented in FIG. 7 is developed as a tetragon and corresponds to a user's arm 3.

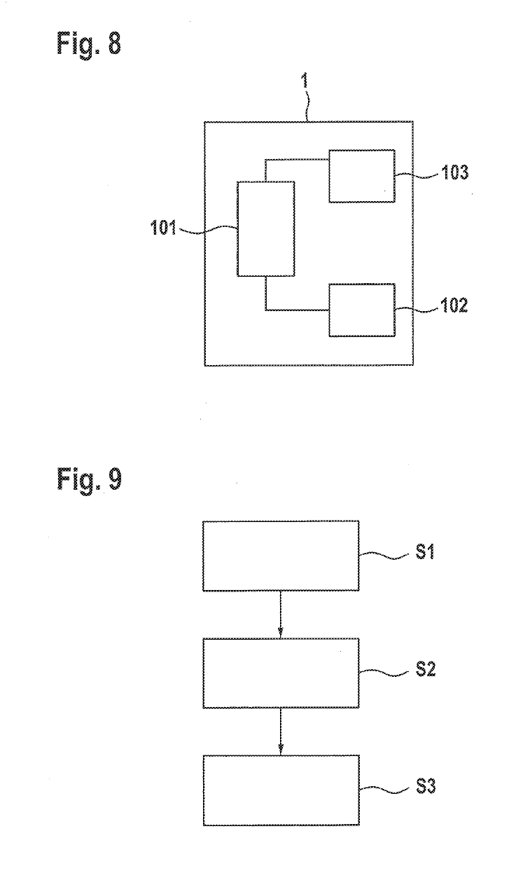

FIG. 8 shows a schematic representation of a device for ascertaining a gesture performed in the light cone of a projected image according to one specific embodiment of the present invention.

A device 1 for ascertaining a gesture performed in the light cone 2a of a projected image 2 includes a data processing device 101, a sensor device 102 and a projector device 103.

FIG. 9 shows a schematic representation of a flow chart of a method for ascertaining a gesture performed in the light cone of a projected image according to one specific embodiment of the present invention.

The illustrated method is for ascertaining a gesture performed in light cone 2a of a projected image 2.

As a first method step, all pixels B of projected image 2 and one or multiple parameter values P of individual pixels B are detected S1.

As a second method step, a comparison S2 is performed of the one or multiple detected parameter values P of individual pixels B with a parameter comparison value PS and an assignment is performed of a subset of pixels B to a pixel set BM as a function of the results of the comparison.

As a third method step, the gesture performed in the light cone 2a of the projected image 2 is ascertained S3 based on the assigned pixel set BM.

The ascertainment S3 of the gesture is performed using a gesture detection algorithm. In order to reduce the amount of data, for example, only the information of assigned pixel set BM is included in the actual detection of the gesture, the data of edge points 6 being analyzed and characteristics being extracted from the data of edge points 6. These characteristics are used as input for ascertaining the gesture to be detected. For this purpose, hidden Markov models, artificial neural networks and other gesture detection techniques are used for example.

What is claimed is:

1. A method for ascertaining a gesture performed in a light cone of a projected image which has a plurality of pixels, comprising:
detecting (i) all pixels of the projected image, and (ii) at least one parameter value of the individual pixels;
comparing the at least one detected parameter value of the individual pixels with a parameter comparison value, and assigning a subset of the pixels to a pixel set as a function of a result of the comparison; and
ascertaining the gesture performed in the light cone of the projected image based on the assigned pixel set.

2. The method as recited in claim 1, wherein the at least one parameter value is defined by distances between (i) the pixels projected onto a projection screen and (ii) a projector device projecting the image.

3. The method as recited in claim 1, wherein the at least one parameter value is defined by reflectivity values of the pixels projected onto a projection screen.

4. The method as recited in claim 2, wherein the assignment of the subset of the pixels to the pixel set is performed as a function of a geometrical shape of the pixel set.

5. The method as recited in claim 4, wherein the detection of the pixels of the projected image is performed by at least one of (i) a column-wise scanning of all pixels of the projected image, and (ii) a row-wise scanning of all pixels of the projected image.

6. The method as recited in claim 5, wherein the at least one of the column-wise scanning and the row-wise scanning of the pixels of the projected image is performed synchronously with at least one of a column-wise projection of the image and a row-wise projection of the image.

7. The method as recited in claim 4, wherein the parameter comparison value is ascertained on the basis of parameter values of previously detected pixels.

8. A device for ascertaining a gesture performed in a light cone of a projected image, comprising:
a projector device for projecting the image onto a projection screen;
a sensor device for detecting all pixels of the projected image and at least one parameter value of the individual pixels; and
a data processing device configured for (i) comparing the at least one detected parameter value of the individual pixels with a parameter comparison value, and assigning a subset of the pixels to a pixel set as a function of a result of the comparison, and (ii) ascertaining the gesture performed in the light cone of the projected image based on the assigned pixel set.

9. The device as recited in claim 8, wherein the sensor device includes a distance sensor for detecting distances between the pixels projected onto the projection screen and the projector device projecting the image.
